(19) United States
(12) Patent Application Publication
(10) Pub. No.: US 2007/0109568 A1
(43) Pub. Date: May 17, 2007

(54) Method and apparatus for printing an image

(76) Inventors: Douglas G. Keithley, Boise, ID (US); Lyman L. Hall, Nampa, ID (US); David A. Bartle, Boise, ID (US); Melvin D. Bodily, Boise, ID (US); Gary Zimmerman, Garden Valley, ID (US)

Correspondence Address: BRINKS HOFER GILSON & LIONE/MARVELL, P.O. BOX 10395, CHICAGO, IL, 60610, US

(21) Appl. No.: 11/281,312

(22) Filed: Nov. 17, 2005

(51) Int. Cl. G06F 15/00

(52) U.S. Cl. 358/1.9; 358/515

(57) ABSTRACT

A method and apparatus for printing an image includes separating the image into colors, partitioning each one of the colors into data blocks, and transferring the data blocks to a printer in an order that the printer will apply the colors to a print medium by transferring, before each one of a plurality of time intervals, one of the data blocks for each one of the colors that will be applied to the print medium during the one of the plurality of time intervals.

### BACKGROUND

Electrophotographic printers employ lasers or light emitting diodes to print images onto a page. Electrophotographic color printers operate by using a select set of colors which are referred to as a color model. One color model that is used is the cyan-magenta-yellow-black (CMYK) color model. To print an image onto a page, the CMYK colors are applied to the page using subtractive color mixing to subtract colors from the white background of the page, thereby allowing light reflected from the page to have the desired colors. Although cyan, magenta and yellow in equal amounts will print black, black toner is used to achieve higher quality printing.

To print an image in a CMYK color space, each of the colors in the CMYK color model is represented numerically by levels that describe the intensity of the color. One approach uses 8 bits per color per pixel to define one of 256 levels of intensity. By combining the colors when using one of the 256 levels of intensity to describe each color, any desired color can be achieved.

Electrophotographic color printers typically operate in a page mode and print images in one page increments. The image information to be printed is typically contained in a single file that includes, for each color, one page of information that defines how the color will be applied to the page. These pages of information, referred to as color planes, are typically aligned before being sent to the printer so that the proper intensity of each color will be applied at each location on the page.

Since the resolution of laser printers can exceed 2400 dots per inch (dpi), the memory storage capacity required by the printer to store the aligned color planes can be significant. Standard image compression techniques such as JPEG (the standard written by the Joint photographic Experts Group) are typically used to lower this requirement. However, even with compression, the memory capacity required by the printer to store the image in the CMYK color space can still be significant.

With in-line laser printers, the memory storage requirement can increase significantly. In-line laser color printers typically use four lasers (one for each of the CYMK colors) to place an image on a page while moving the page through the printer in one direction. An image sent from a host to the in-line laser printer is typically defined in a Red-Green-Blue (RGB) color space, and the in-line laser printer converts the image from the RBG color space to the CYMK color space. Since the lasers can apply colors to different portions of a page or to different pages at the same time, each image hardware path for each laser typically stores a complete copy of the image for multiple pages. If image compression is used, each image hardware path decompresses the RGB image before performing color space conversion from RGB to CYMK. Thus electrophotographic color printers, and in-line laser color printers in particular, typically employ significant amounts of memory as well as decoding hardware to perform color space conversion.

For these and other reasons, this is a need for the present invention.

### SUMMARY

One aspect of the invention provides a method for printing an image. The method comprises separating the image into colors, partitioning each one of the colors into data blocks, and transferring the data blocks to a printer. The data blocks are transferred in an order that the printer will apply the colors to a print medium by transferring, before each one of a plurality of time intervals, one of the data blocks for each one of the colors that will be applied to the print medium during the one of the plurality of time intervals.

### BRIEF DESCRIPTION OF THE DRAWINGS

FIG. 1 is a block diagram illustrating one embodiment of an image processing system.

FIG. 2 is a diagram illustrating one embodiment of an electrophotographic printer.

FIG. 3 is a diagram illustrating one embodiment of an application of colors to a print medium by an electrophotographic printer as a function of time.

FIG. 4 is a diagram illustrating one embodiment of a transfer of data blocks to an electrophotographic printer in an order that the printer will apply the colors to a print medium.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top”,“bottom”, “front”,“back,” “leading,” “trailing,” etc. is used with reference to the orientation of the Figures(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

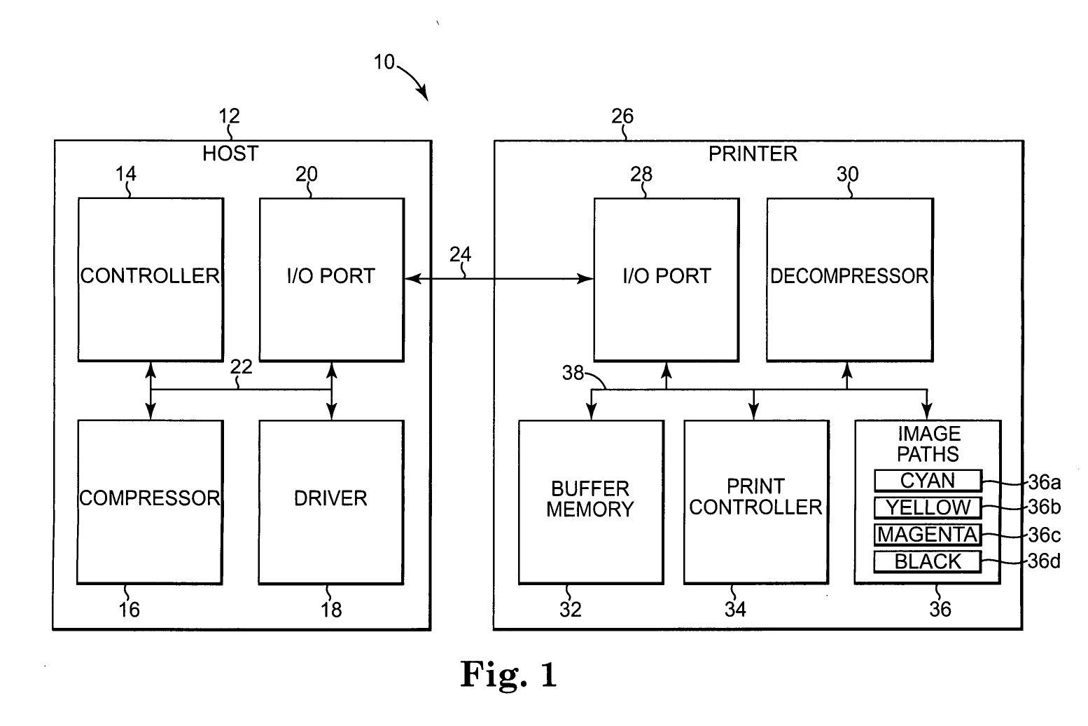

FIG. 1 is a block diagram illustrating one embodiment of an image processing system 10. Image processing system 10 includes a host 12 and an electrophotographic printer 26. In the illustrated embodiment, host 12 includes a controller 14, a compressor 16, driver 18 and an I/O port 20, all of which are coupled to a bus 22. Printer 26 includes I/O port 28, decompressor 30, buffer memory 32, print controller 34 and image paths 36, all of which are coupled to a bus 38. Printer 26 is coupled to host 12 via bus 24. Bus 24 is coupled between I/O port 20 and I/O port 28.

In the illustrated embodiment, controller 14 converts an image from the red-green-blue (RGB) color space to the cyan-magenta-yellow-black (CYMK) color space before sending the image to printer 26. Host 12 retains images in the RGB color space format because information is displayed by host 12 using additive color mixing with red, green and blue. The image in the CYMK color space is separated into cyan, yellow, magenta and black colors or color planes.

In the illustrated embodiment, controller 14 is configured to separate or partition an image to be printed into separate colors and to partition each one of the colors into data blocks 72, 74, 76, 78, 80, 82, 84 or 86 that define how printer 26 will apply the colors to print medium 54. Compressor 16 reduces the size of data blocks 72, 74, 76, 78, 80, 82, 84 or 86 by using a suitable standard image compression technique (e.g., JPEG (the standard written by the Joint Photographic Experts Group) or JBIG (the standard written by the Joint Bi-level Image Expert Group)). While JPEG and JBIG each have certain advantages, such as JPEG has the advantage of being able to store 24 bits/pixel for a total of 16,777,216 possible colors, in other embodiments, the data blocks 72, 74, 76, 78, 80, 82, 84 or 86 are not compressed or are compressed using other suitable approaches.

In the illustrated embodiment, driver 18 sends data and instructions between host 12 and printer 26. Data blocks 72, 74, 76 and 78 are provided by host 12 to printer 26 via driver 18 and I/O port 20 through time interval T9, and data blocks 80, 82, 84 and 86 are provided by host 12 to printer 26 via driver 18 and I/0 port 20 through time interval T16. The data blocks are provided in the order that printer 26 will apply the colors to print medium 54. That is, before each one of the time intervals T, one or more data blocks 72, 74, 76, 78, 80, 82, 84 or 86 are received from host 12 that define how the image paths 36 will apply the colors to the print medium 54 during the time interval T.

In the illustrated embodiment, before each one of the time intervals T1 through T9 for page 1 and time intervals T8 through T16 for page 2, one of the data blocks 72, 74, 76, 78, 80, 82, 84 or 86 is transferred to the printer for each one of the colors that is applied to print medium 54 during the time intervals TI through T16. In this embodiment, the CMYK color model is used and the colors applied to the print medium are cyan (data blocks 72 and 80), yellow (data blocks 74 and 82), magenta (data blocks 76 and 84) and black (data blocks 78 and 86). In other embodiments, other suitable color models and colors can be used. In other embodiments, the print medium can be paper or can include any suitable surface area upon which colors can be applied.

In the illustrated embodiment, electrophotographic printer 26 is an in-line color laser printer. In other embodiments, electrophotographic printer 26 can be other suitable types of printers such as a Light Emitting Diode (LED) printer. In this embodiment, the in-line color laser printer 26 applies the colors in an order to print medium 54 as print medium 54 is moved through printer 26. Printer 26 uses image path 36a for cyan, image path 36b for yellow, image path 36c for magenta and image path 36d for black. Each image path includes a laser which is used to apply one of cyan, yellow, magenta or black to print medium 54. While only cyan, yellow and magenta are required to print a color image on print medium 54, the use of black helps create a higher quality image. Each image path 36 applies either cyan, yellow, magenta or black to the print medium 54 for a time period that includes consecutive time intervals to form the image. Each time period for each one of the image paths begins at different times. Because printer 26 is an in-line printer, in this embodiment, the colors are applied to print medium 54 while moving the print medium 54 through printer 26 in only one direction.

In the illustrated embodiment, decompressor 30 decompresses the data blocks 72, 74, 76, 78, 80, 82, 84 or 86 so that they can be used in an uncompressed format. In other embodiments, the data blocks 72, 74, 76, 78, 80, 82, 84 or 86 are not compressed by host 12. In other embodiments, any suitable compression and decompression approach can be used by compressor 16 and decompressor 30, respectively. In the illustrated embodiment, buffer memory 32 stores any of the data blocks 72, 74, 76, 78, 80, 82, 84 or 86 that are to be printed either before the printing begins or while the printer is printing other information. If compression is used, less storage space is needed by buffer memory 32.

In the illustrated embodiment, print controller 34 controls the print quality and speed of printer 26. Print controller 34 communicates with host 12 via bus 24 to determine how information will be exchanged between host 12 and printer 26 and to determine how the data blocks 72, 74, 76, 78, 80, 82, 84 or 86 will be applied to print medium 54. In various embodiments, bus 24 can be any suitable communications interface such as a parallel port, a USB port (the standard by the USB Implementers Forum), firewire or network interface. I/O ports 20 and 28 are configured to send and receive information over bus 24 in accordance with the type of port used. In the illustrated embodiment, print controller 34 performs tasks such as storing data blocks 72, 74, 76, 78, 80, 82, 84 or 86 in buffer memory 32 as needed and can perform other suitable tasks such as organizing and storing multiple printing requests into a queue. Print controller 34 communicates with host 12 to start and stop the transfer of information and to organize the data blocks 72, 74, 76, 78, 80, 82, 84 or 86 once they are received. Print controller 34 also controls image paths 36 and the application of the information in the data blocks to print medium 54. Print controller 34 also can control such items as page formatting, font handling etc.

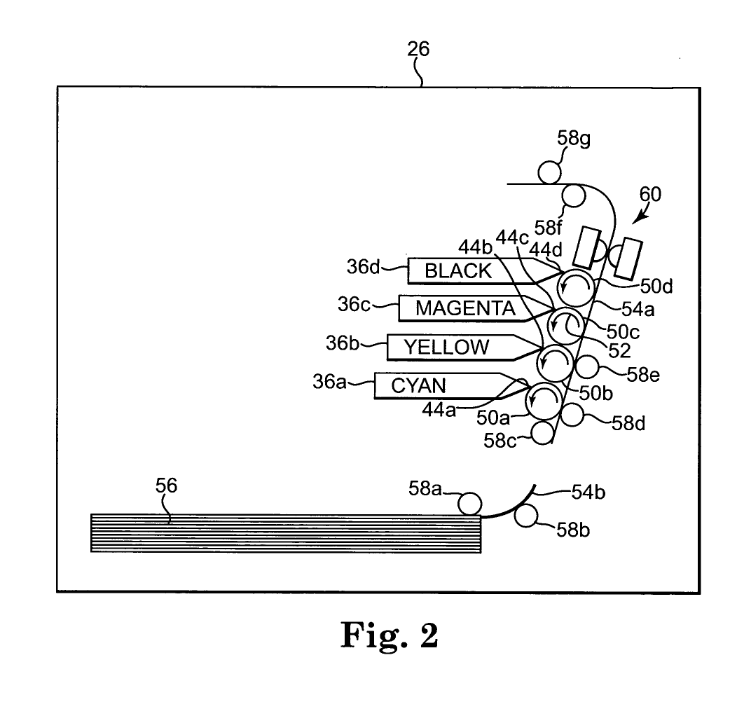

FIG. 2 is a diagram illustrating one embodiment of an in-line electrophotographic printer 26. FIG. 2 is a simplified mechanical diagram of the printer 26 shown in FIG. 1 and illustrates the application of the image to print medium 54. Details regarding the electrophotographic method are omitted for clarity. In this embodiment, printer 26 includes image paths 36a-36d which respectively apply the image to corresponding drums 50a-50d. Each image path 36 includes a toner cartridge for the respective color that is being applied to the corresponding drum 50 (e.g. cyan, magenta, yellow and black), and includes a laser to transfer the image. Image paths 36 transfer the image to corresponding drums 50 by using the lasers to discharge portions of corresponding drums 50 so that the toner for the colors can be applied to the corresponding drums 50. Image path 36a transfers cyan to drum 50a at 44a. Image path 36b transfers yellow to drum 50b at 44b. Image path 36c transfers magenta to drum 50c at 44c. Image path 36d transfers black to drum 50d at 44d. In one embodiment, the spacing between application areas 44a, 44b, 44c and 44d is approximately two inches. In other embodiments, this spacing can be any suitable amount. In various embodiments, the lasers have a resolution that can range from less than 300 dots per inch (dpi) to greater than 1,200 dpi. Although each of the colors are individually applied to the corresponding drums 50, in the illustrated embodiment, the colors are overlapping and are combined to form the image which is transferred to print medium 54 via drums 50.

In the illustrated embodiment, drums 50a-50d rotate in the direction indicated by arrows 52. As drums 50 rotate in the direction indicated by arrows 52, the image surface area or the portion of the corresponding drums 50a -50d that the image is being transferred to will move past the corresponding application areas 44a, 44b, 44c and 44d. In one embodiment, cyan is the first color to be applied and black is the last color to be applied. As the colors are overlapping and are combined to form the image, other suitable orders of color application can be used in other embodiments. In the illustrated embodiment, as drum 50a rotates in the direction indicated by arrows 52, image data to transfer cyan to drum 50a is first required for cyan at 44a. At 44b, image data to transfer yellow to drum 5Ob is first required and additional information is required for cyan. At 44c, image data to transfer magenta to drum 50c is first required and additional information is required for yellow and cyan. At 44d, image data to transfer black to drum 50d is first required and additional information is required for magenta, yellow and cyan. As drums 50 continue to rotate, the last of the cyan image data is required before the last of the yellow, magenta and black information. The last of the yellow image data is required before the last of the magenta and black information. And the last of the magenta information is required before the last of the black information.

In the illustrated embodiment, print medium 54a is printed first and print medium 54b is printed second. Print medium 54a and 54b are moved from paper tray 56 by roller 58a and are spaced about 0.5 inches apart as they pass under drum 50. Rollers 58a-58g guide print medium 54 under drums 50 so that the image can be transferred to print medium 54. Print medium 54 is then moved through fuser 60 which includes a pair of heated rollers that melts the loose toner powder causing it to fuse with the fibers in print medium 54. Print medium 54a and 54b are deposited in a paper bin after the image transfer is complete (not shown). In one embodiment, print medium 54a and 54b are sheets of paper and print medium 54a is the first page to be printed (e.g. page one) and print medium 54b is the second page to be printed (e.g. page two). In other embodiments, print medium 54 can be any suitable print medium upon which colors can be applied. Although print medium 54a and print medium 54b are illustrated, in other embodiments there can be any suitable number of print mediums, such as one or more than two.

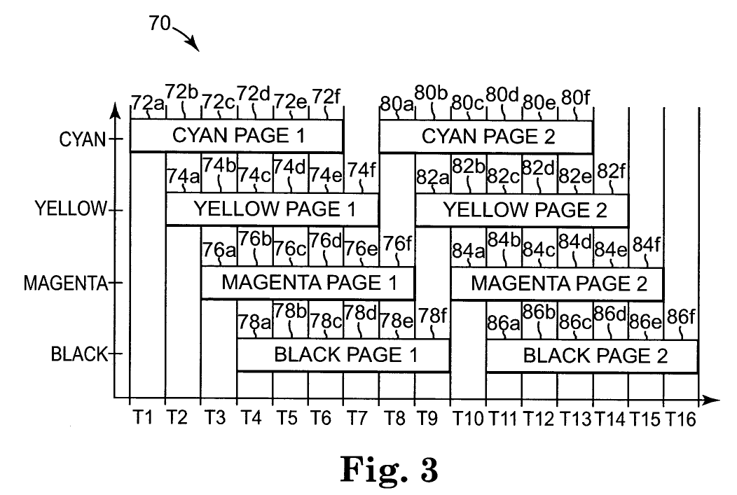

FIG. 3 is a diagram illustrating one embodiment of an application of colors to a print medium 54 by electrophotographic printer 26 as a function of time. In the illustrated embodiment, host 12 converts the image from first color space image data in the RGB color space to second color space image data in the CYMK color space. Each page of information for cyan, magenta, yellow and black is referred to as a color plane. In the illustrated embodiment, 8 bits per color per pixel are used which each define 256 levels or intensities for each one of the colors. By combining the color planes when using one of the 256 levels for each color, all colors in the original image can be reproduced.

After separating the image into the colors of cyan, yellow, magenta and black, host 12 further divides or partitions the second color space image data for each one of the colors into color plane data files or data blocks 72, 74, 76, 78, 80, 82, 84 or 86. Data blocks 72 and 80 contain color plane information for page one and page two, respectively, for cyan, data blocks 74 and 82 contain color plane information for page one and page two, respectively, for yellow, data blocks 76 and 84 contain color plane information for page one and page two, respectively, for magenta and data blocks 78 and 86 contain color plane information for page one and page two, respectively, for black. Host 12 transfers the data blocks to printer 26 in an order that printer 26 will apply the colors to print medium 54 by transferring, before each one of the time intervals T, one of the data blocks for each one of the colors that will be applied to the print medium by printer 26 during the time interval T. In one embodiment, the time intervals T for each of the colors are consecutive and correspond to a time that a location on print medium 54 moves from 44a to 44b, from 44b to 44c, or from 44c to 44d.

The data block size does not need to line up with the time slot. For example, in one embodiment, the time between the start of the different colors is not an integer or a single time period equal to the amount of data in a block.

In the illustrated embodiment at 70, sixteen time intervals T are used to apply two pages of image information to print medium 54 for each of cyan, yellow, magenta and black. The image data for each page and for each color is divided into six data blocks. In other embodiments, other suitable numbers of data blocks can be used. Because each one of the data blocks 72, 74, 76, 78, 80, 82, 84 or 86 is transferred to printer 26 in the order that the image information is contained within the data blocks, a higher number of data blocks for each page can be used if buffer memory 32 has a smaller memory storage capacity, and a smaller number of data blocks for each page can be used if buffer memory 32 has a higher memory storage capacity. In the illustrated embodiment, for each one of cyan, yellow, magenta or black, the data blocks are transferred to printer 26 for print medium 54a and print medium 54b in consecutive time intervals. For each page, each one of the colors is transferred in a number of data blocks that is the same as for every other color. Since a location on print medium 54 moves past 44a , 44b, 44c and 44d at different times, the first data block for each color is transferred at a unique time, and the time period for transferring each of the colors begins and ends at unique times.

In the illustrated embodiment, each of the image paths 36 apply the respective color to corresponding drum 50 in six time intervals T for either print medium 54a or print medium 54b. Thus cyan for print medium 54a (illustrated as page one) is applied during time intervals T1 through T6, cyan for print medium 54b (illustrated as page two) is applied during time intervals T8 through T13, yellow for page one is applied during time intervals T2 through T7, yellow for page two is applied during time intervals T9 through T14, magenta for page one is applied during time intervals T3 through T8, magenta for page two is applied during time intervals T10 through T15, black for page one is applied during time intervals T4 through T9, and black for page two is applied during time intervals T11 through T16.

In one embodiment, each one of the data blocks 72, 74, 76, 78, 80, 82, 84 or 86 contains image information for one color and for one-sixth of the image to be placed on print medium 54a or print medium 54b. Since there are four colors, an image is transferred to print medium 54a with a total of 24 data blocks (e.g. data blocks 72, 74, 76 and 78), and an image is transferred to print medium 54b with a total of 24 data blocks (e.g. data blocks 80, 82, 84 and 86). In other embodiments, the image for either print medium 54a or print medium 54b can be transferred in any suitable numbers of data blocks.

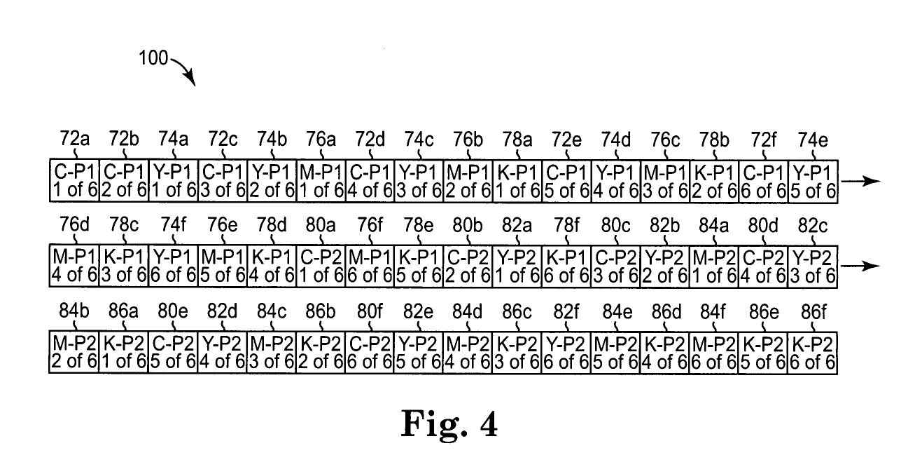

FIG. 4 is a diagram illustrating one embodiment of the transfer of data blocks 72, 74, 76, 78, 80, 82, 84 or 86 to electrophotographic printer 26 in an order that the printer 26 will apply the colors to print medium 54. Although the diagram at 100 illustrates a serial transfer of the data blocks, in other embodiments, the transfer of data blocks 72, 74, 76, 78, 80, 82, 84 or 86 can be in parallel between host 12 and printer 26, or can be in any suitable combination of serial and parallel.

The diagram at 100 illustrates that the order of transfer begins with data block 72a for cyan and continues through data block 74e for yellow, continues with data block 76d for magenta and continues through data block 82c for yellow, and continues with data block 84b for magenta and continues through data block 86f for black. In one embodiment, each one of the data blocks 72, 74, 76, 78, 80, 82, 84 or 86 are compressed using a JPEG or JBIG algorithm by compressor 16 before being sent to printer 26, and are decompressed by decompressor 30 before the respective colors are applied to photoconductor belt 42. In other embodiments, other suitable compression and decompression algorithms are used or no compression is used.

Referring to FIG. 3 and FIG. 4, before time interval T1, data block 72a, which is first of six data blocks for page one of cyan, is transferred from host 12 to printer 26. The laser for image path 36a is the first laser that applies a color (e.g. cyan) to a moving surface of a corresponding drum 50 (e.g. drum 50a). This is because the area of drum 50a that retains the image moves past the laser for cyan at 44a before the area of drum 50b that retains the image moves past the laser for yellow at 44b, the area of drum 50c that retains the image moves past the laser for magenta at 44c, and the area of drum 50d that retains the image moves past the laser for black at 44d. In one embodiment, one of the time intervals T is equal to or less than a time that print medium 54 moves between 44a and 44b, 44b and 44c, or 44c and 44d.

Next, before time interval T2, data block 72b, which is the second of six data blocks for page one of cyan, and data block 74a, which is the first of six data blocks for page one of yellow, are transferred from host 12 to printer 26. Before time interval T3, data block 72c, which is the third of six data blocks for page one of cyan, data block 74b, which is the second of six data blocks for page one of yellow, and data block 76a, which is the first of six data blocks for page one of magenta, are transferred from host 12 to printer 26. Before time interval T4, data block 72d, which is the fourth of six data blocks for page one of cyan, data block 74c, which is the third of six data blocks for page one of yellow, data block 76b, which is the second of six data blocks for page one of magenta and data block 78a, which is the first of six data blocks for page one of black, are transferred from host 12 to printer 26. Before time interval T5, data block 72e, which is the fifth of six data blocks for page one of cyan, data block 74d, which is the fourth of six data blocks for page one of yellow, data block 76c, which is the third of six data blocks for page one of magenta, and data block 78b, which is the second of six data blocks for page one of black, are transferred from host 12 to printer 26. Before time interval T6, data block 72f, which is the sixth of six data blocks for page one of cyan, data block 74e, which is the fifth of six data blocks for page one of yellow, data block 76d, which is the fourth of six data blocks for page one of magenta, and data block 78c, which is the third of six data blocks for page one of black, are transferred from host 12 to printer 26. Before time interval T7, data block 74f, which is the sixth of six data blocks for page one of yellow, data block 76e, which is the fifth of six data blocks for page one of magenta, and data block 78d, which is the fourth of six data blocks for page one of black, are transferred from host 12 to printer 26. Before time interval T8, data block 80a, which is the first of six data blocks for page two of cyan, data block 76f, which is the sixth of six data blocks for page one of magenta, and data block 78e, which is the fifth of six data blocks for page one of black, are transferred from host 12 to printer 26. Before time interval T9, data block 80b, which is the second of six data blocks for page two of cyan, data block 82a, which is the first of six data blocks for page two of yellow, and data block 78f, which is the sixth of six data blocks for page one of black, are transferred from host 12 to printer 26. Before time interval T10, data block 80c, which is the third of six data blocks for page two of cyan, data block 82b, which is the second of six data blocks for page two of yellow, and data block 84a, which is the first of six data blocks for page two of magenta, are transferred from host 12 to printer 26. Before time interval T11, data block 80d, which is the fourth of six data blocks for page two of cyan, data block 82c, which is the third of six data blocks for page two of yellow, data block 84b, which is the second of six data blocks for page two of magenta, and data block 86a, which is the first of six data blocks for page two of black, are transferred from host 12 to printer 26. Before time interval T12, data block 80e, which is the fifth of six data blocks for page two of cyan, data block 82d, which is the fourth of six data blocks for page two of yellow, data block 84c, which is the third of six data blocks for page two of magenta, and data block 86b, which is the second of six data blocks for page two of black, are transferred from host 12 to printer 26. Before time interval T13, data block 80f, which is the sixth of six data blocks for page two of cyan, data block 82e, which is the fifth of six data blocks for page two of yellow, data block 84d which is the fourth of six data blocks for page two of magenta, and data block 86c, which is the third of six data blocks for page two of black, are transferred from host 12 to printer 26. Before time interval T14, data block 82f, which is the sixth of six data blocks for page two of yellow, data block 84e, which is the fifth of six data blocks for page two of magenta, and data block 86d, which is the fourth of six data blocks for page two of black, are transferred from host 12 to printer 26. Before time interval T15, data block 84f, which is the sixth of six data blocks for page two of magenta, and data block 86e, which is the fifth of six data blocks for page two of black, are transferred from host 12 to printer 26. And last, before time interval T16, data block 86f, which is the sixth of six data blocks for page two of black, is transferred from host 12 to printer 26.

In the illustrated embodiment, the size of buffer memory 32 is minimized because the entire image to be printed on print medium 54 does not need to be stored in buffer memory 32. The data blocks 72, 74, 76, 78, 80, 82, 84 or 86 are transferred before each time interval T as needed, thereby reducing the amount of memory required to store the image. Since the data blocks transferred from host 12 to printer 26 are in the CYMK color space, printer 26 does not have to perform color space conversion. Since each color plane for each color is divided into suitably sized data blocks, the amount of image information being managed by print controller 34 is minimized and the image information in one of the data blocks can be applied to the corresponding drum 50 before image information in another one of the data blocks is applied to another corresponding drum 50, thereby avoiding having to switch between color planes of image data.

In one illustrative example, during the time in interval T4, if the color plane data is aligned in memory, the printer is employing data from the first four blocks of color planes for page one. Consequently, 16 blocks of data need to be present in the printer (the first four of all four colors). By contrast, with one embodiment of a non-aligned data printer according to the present invention, only the four blocks of data that actually represent data this is currently being printed on the page need to be present in the printer.

Although specific embodiments have been illustrated and described herein, it will be appreciated by those of ordinary skill in the art that a variety of alternate and/or equivalent implementations may be substituted for the specific embodiments shown and described without departing from the scope of the invention. This application is intended to cover any adaptations or variations of the specific embodiments discussed herein. Therefore, it is intended that this invention be limited only by the claims and the equivalents thereof.

What is claimed is:

1. A method of printing an image, comprising:
separating the image into colors;
partitioning each one of the colors into data blocks;
transferring the data blocks to a printer in an order that the printer will apply the colors to a print medium by transferring, before each one of a plurality of time intervals, one of the data blocks for each one of the colors that will be applied to the print medium during the one of the plurality of time intervals.

2. The method of claim 1, wherein for each of the one of the colors, the data blocks are transferred to the printer for a time period to apply the one of the colors to the print medium, and wherein the time period includes at least two time intervals.

3. The method of claim 2, wherein the time periods for each of the one of the colors are equal and begin at different times.

4. The method of claim 1, wherein separating an image into colors comprises converting the image from a first color space to a second color space.

5. The method of claim 4, wherein the first color space is a red-green-blue color space and the second color space is a cyan-magenta-yellow-black color space.

6. The method of claim 1, wherein partitioning each one of the colors into data blocks comprises compressing the data blocks.

7. An electrophotographic image processing system, comprising:
a controller configured to separate an image into colors and to partition each one of the colors into data blocks that define how a printer will apply the colors to a print medium, wherein the data blocks are defined to be in an order that the printer will apply the colors to the print medium during time intervals; and
a driver configured to transfer the data blocks in the order to the printer, wherein before each one of the time intervals, one of the data blocks is transferred to the printer for each one of the colors that is applied to the print medium during the one of the time intervals.

8. The electrophotographic image processing system of claim 7, wherein for each of the one of the colors, the data blocks are transferred to the printer in the order for a time period that includes consecutive time intervals.

9. The electrophotographic image processing system of claim 7, wherein the time periods for each of the one of the colors are equal and begin at different times.

10. The electrophotographic image processing system of claim 7, wherein the time periods for each of the one of the colors are not equal and begin at different times.

11. The electrophotographic image processing system of claim 7, wherein the printer comprises:
a first laser configured to apply a first one of the colors to a first moving surface in order to transfer the first one of the colors to the print medium; and
a second laser configured to apply a second one of the colors to a second moving surface in order to transfer the second one of the colors to the print medium, wherein each of the one of the time intervals is equal to or less than a time that a location on the print medium moves between the first laser and the second laser when the printer is applying the colors to the print medium.

12. The electrophotographic image processing system of claim 7, wherein the controller converts the image from a first color space to a second color space before separating the image into colors.

13. A method of forming an image onto a print medium, comprising:
dividing image data for a number of colors into data blocks;
moving the print medium through a printer over a plurality of time intervals; and
before each one of the plurality of time intervals, transferring one of the data blocks to the printer for each one of the number of colors that is being formed on the print medium during the one of the plurality of time intervals.

14. The method of claim 13, wherein the print medium comprises a number of pages, and wherein dividing the image data comprises dividing, for each one of the number of pages, the image data for each of the one of the number of colors into two or more of the data blocks.

15. The method of claim 14, wherein for each of the one of the number of colors, the data blocks are transferred to the printer for each of the one of the number of pages for a number of the plurality of time intervals that are consecutive and equal to the number of the plurality of time intervals that every other color is applied to the print medium, and wherein a first one of the data blocks transferred to the printer for each of the one of the number of colors is transferred at a unique time.

16. The method of claim 13, wherein the number of colors includes at least one of cyan, yellow, and magenta.

17. The method of claim 13, wherein dividing the image data for the number of colors into the data blocks comprises:
converting first color space image data into second color space image data;
separating the second color space image data into a number of color plane data files, wherein each one of the number of color plane data files corresponds to the one of the number of colors; and
dividing each of the one of the number of color plane data files into two or more of the data blocks.

18. An electrophotographic printer, comprising:
image paths, wherein each one of the image paths is configured to apply a unique color to a page for a time period that includes consecutive time intervals to form an image, and wherein the time period for each of the one of the image paths begins at different times; and
a controller configured to provide data blocks received from a host to the image paths, wherein before each one of the consecutive time intervals, one or more data blocks are received from the host, wherein each one of the one or more data blocks defines how the one of the image paths will apply the color to the page during the one of the consecutive time intervals.

19. The electrophotographic printer of claim 18, wherein there are at least three image paths, wherein the time period for a first image path begins during a first time interval before which the first image path receives the one of the one or more data blocks from the host and applies the color to the page, wherein the time period for a second image path begins during a second time interval before which the first image path and the second image path each receive the one of the one or more data blocks from the host and apply the color to the page during the second time interval, wherein the time period for a third image path begins during a third time interval before which the first image path, the second image path and the third image path each receive the one of the one or more data blocks from the host and apply the color to the page during the third time interval.

20. The electrophotographic printer of claim 19, wherein the first time interval, the second time interval and the third time interval are consecutive.

21. The electrophotographic printer of claim 18, wherein each of the one of the one or more data blocks is generated by separating color space image data into color plane data files, and wherein each one of the color plane data files is divided into two or more of the data blocks.
